(19) United States
(12) Patent Application Publication
(10) Pub. No.: US 2024/0242300 A1
(43) Pub. Date: Jul. 18, 2024

(54) NAME IDENTIFICATION PROCESSING DEVICE, METHOD OF MAKING NAME IDENTIFICATION LIST AND METHOD OF NAME IDENTIFICATION PROCESSING

(71) Applicant: IPDEFINE LTD., Tokyo (JP)

(72) Inventor: Mitsuhiro OKAMOTO, Tokyo (JP)

(73) Assignee: IPDEFINE LTD., Tokyo (JP)

(21) Appl. No.: 18/558,305

(22) PCT Filed: Jun. 1, 2022
(86) PCT No.: PCT/JP2022/022255

§ 371 Date: Oct. 31, 2023

(30) Foreign Application Priority Data
May 15, 2021 (JP) 2021-082844

(51) Int. Cl. G06Q 50/18

(52) U.S. Cl. CPC G06Q 50/184

(57) ABSTRACT

A name identification processing device produces name identification list by accessing to an intellectual property database, collecting name data and family ID of industrial property rights that are subjected to listing, and organizing collected name data based on the family ID. The name identification processing device enables accurate name identification irrespective of a degree of similarity between names.

The present disclosure relates to a name identification processing device for such as company names, method of making name identification list and method of name identification processing.

Company databases managed by financial institutions, for example, store a variety of information associated with company and individual names. In such databases, one company may be managed as another because of the existence of abbreviated company names, name changes, data integration due to company mergers, or notation errors caused by incorrect input.

This leads to a decrease in social credibility and marketing ROI (Return On Investment) of the company. Conventionally, a name identification process has been performed to assign a common name or identifying information to the same company (see, for example, Patent Document 1).
Patent Document 1: JP-A-2015-125455

### SUMMARY

### Technical Problem

However, the name identification processing method in the Patent Document 1 only supports simple cleansing of the company name, such as elimination of name fluctuation, common alphabetization, and deletion of branch names. The conventional method of the Patent Document 1 makes name identification difficult in cases where the similarity between names is low, i.e., when there is little in common between names. Especially for global companies, company names are written differently in different countries, and in many cases, the similarity between names in different countries is low. Therefore, a method to achieve highly accurate name identification is desired, even when different names are associated with the same company and the similarity between the names is low.

The purpose of the present disclosure is to solve the above-mentioned problems and to provide a name identification processing device for such as company names, method for making name identification list and method for processing name identification that achieve highly accurate name identification regardless of the degree of similarity between company names.

### Solution to Solve Problem

According to one embodiment, a name identification processing device comprising a control unit, and wherein the control unit is configured to produce a name identification list by accessing to an intellectual property database in which one or more name data indicating the applicant or right holder for one invention or device is associated with one family ID, collecting the name data and the family ID of industrial property rights that are subjected to listing and organizing the collected name data based on the family ID is disclosed.

According to another embodiment, a name identification processing device comprising a control unit, and wherein the control unit is configured to match the external database in which multiple company data are listed with an intellectual property database in which one or more name data indicating the applicant or right holder for one invention or device is associated with one family ID, and organize by assigning a common data to the company data in the external database that matches the name data to which the same family ID is linked is disclosed.

According to another embodiment, a method of making a name identification list, the method comprising accessing to an intellectual property database in which one or more name data indicating the applicant or right holder for one invention or device is associated with one family ID; collecting the name data and the family ID of industrial property rights that are subjected to listing; and organizing the collected name data based on the family ID is disclosed.

According to another embodiment, a method of name identification processing, comprising matching the external database in which multiple company data are listed with an intellectual property database in which one or more name data indicating the applicant or right holder for one invention or device is associated with one family ID; and organizing by assigning a common data to the company data in the external database that matches the name data to which the same family ID is linked is disclosed.

### Advantageous Effects

The embodiment is designed to perform the name identification process utilizing an intellectual property database in which one family ID is associated with one or more name data indicating the applicant or right holder for one invention or device. In these days, many companies file patent applications for the same invention in multiple countries, and such a group of patent applications is called a patent family. A family ID is identification information commonly assigned among patent families, and the same family ID is assigned to the same company, no matter how far apart the company names are written. Therefore, according to the present embodiment, highly accurate name identification processing can be achieved regardless of the degree of similarity between company names.

### FIGURES

FIG. 1: A block diagram illustrating the name identification processing device and its peripheral configuration of the Embodiment 1.

FIG. 2: A table of multiple name data and family IDs associated with them extracted by the name identification processing device in FIG. 1.

FIG. 3: A table showing an example of name identification list produced by the name identification processing device in FIG. 1.

FIG. 4: A table showing an example of multiple name data associated with a company and the family IDs associated with them that are extracted by the name identification processing device in FIG. 1.

FIG. 5: A table showing an example of name identification list produced by the name identification processing device in FIG. 1 according to maximum number condition.

FIG. 6: A table showing an example of name identification list produced by the name identification processing device in FIG. 1 according to total data condition or data appearance rate condition.

FIG. 7: A table showing another example of multiple name data associated with a company and the family IDs associated with them that are extracted by the name identification processing device in FIG. 1.

FIG. 8: A table showing an example of multiple name data associated with a company and the family IDs associated with them including name data of joint applicant company, that are extracted by the name identification processing device in FIG. 1.

FIG. 9: A flow chart an example of a method of making a name identification list and a method for processing name identification of the Embodiment 1.

FIG. 10: A block diagram illustrating the name identification processing device and its peripheral configuration of the Variation 1 of the Embodiment 1.

FIG. 11: A flow chart an example of a method of making a name identification list and a method for processing name identification of the Variation 1 of the Embodiment 1.

FIG. 12: Example illustration of the name identification processing device in FIG. 10 matching between the name data in the name identification list and the name data in the company database.

FIG. 13: Example illustration of the name identification processing device in FIG. 10 adding a company data to the name identification list.

FIG. 14: A block diagram illustrating the name identification processing device and its peripheral configuration of the Variation 2 of the Embodiment 1.

FIG. 15: A flow chart an example of a method of making a name identification list and a method for processing name identification of the Variation 2 of the Embodiment 1.

FIG. 16: Example illustration of the name identification processing device in FIG. 14 matching between the name data in the name identification list and the name data in the company database.

FIG. 17: Example illustration of the name identification processing device in FIG. 14 assigning common data to the company data that matches the name data associated with the same family ID.

FIG. 18: Example illustration of the name identification processing device in FIG. 14 assigning common data to the company names with similarity.

FIG. 19: A block diagram illustrating the name identification processing device and its peripheral configuration of the Embodiment 2.

FIG. 20: A flow chart an example of a method of making a name identification list and a method for processing name identification of the Embodiment 2.

FIG. 21: Example illustration of the name identification processing device in FIG. 19 matching between the name data in the intellectual property database and the company data entered externally.

FIG. 22: A block diagram illustrating the name identification processing device and its peripheral configuration of the Embodiment 3.

FIG. 23: A flow chart an example of a method of making a name identification list and a method for processing name identification of the Embodiment 3.

FIG. 24: Example illustration of the name identification processing device in FIG. 22 matching between name data in the intellectual property database and company data in the company database.

FIG. 25: Example illustration of the name identification processing device in FIG. 22 organizing company data in the company database that corresponds to the name data in the intellectual property database.

FIG. 26: Example illustration of the name identification processing device in FIG. 22 organizing company data in the company database that is similar to the name data in the intellectual property database.

### DETAILED DESCRIPTION

### Embodiment 1

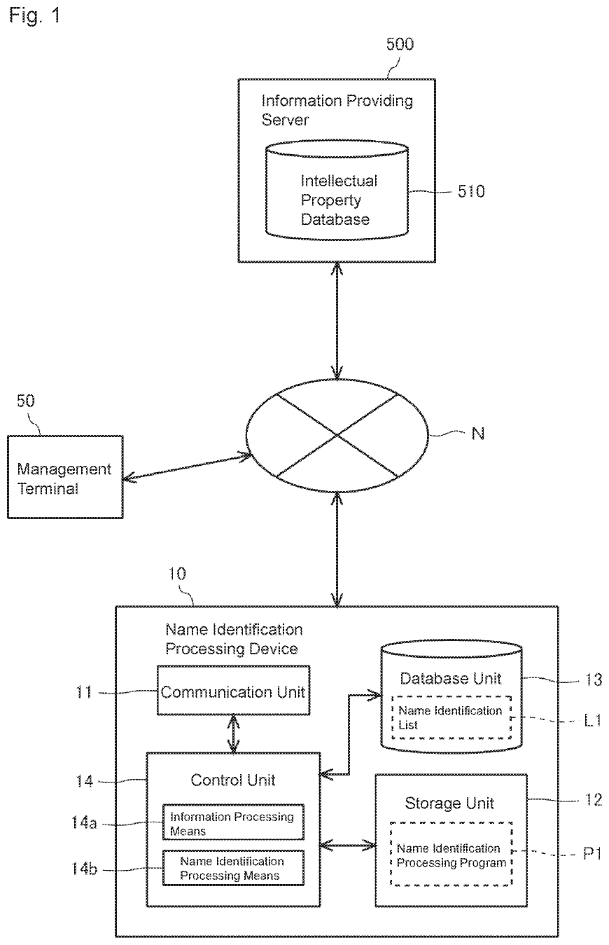

Referring to FIG. 1, an example of the name identification processing device and its peripheral configuration of the Embodiment 1 is explained. As shown in FIG. 1, a name identification processing device 10 is communicatively connected to a management terminal 50 and an information providing server 500 via a network N such as the Internet. The management terminal 50 is, for example, a PC (Personal Computer) used by a company that manages software and data in the name identification processing device 10. The PC includes a tablet PC, a notebook PC, a desktop PC, etc.

The information providing server 500 is a server device operated by patent offices around the world, which provides information on industrial property rights through an API (Application Programming Interface), for example. The information providing server 500 has an intellectual property database 510 that stores information on industrial property rights. In the intellectual property database 510, one family ID is associated with one or more name data indicating the applicant or right holder for one invention or device. In other words, in the information on industrial property rights, at least the application number, name data, and family ID are associated with each other. Hereafter, inventions or devices are also referred to as “inventions, etc.” and applicants or right holders are also referred to as “applicants, etc.”. The information providing server 500 is composed of a cloud server based on cloud computing, or an on-premise physical server, or a system that combines these two, or the like.

Industrial property rights refer to patent rights, utility model rights, design rights, and trademark rights among intellectual property rights. In the Embodiment 1, it refers specifically to patent rights and utility model rights. In principle, information on industrial property rights includes information on applications that have been granted rights (including those that have expired due to expiration of the duration), information on applications that have not been granted rights, and information on applications that are under examination or awaiting examination before being granted rights. Hereinafter, information on industrial property rights is also referred to as “rights-related information”. Rights-related information includes, at least, name data indicating the applicant and a family ID associated with the name data.

The name identification processing device 10 produces an organized name identification list L1 based on family ID. The name identification processing device 10 may provide the produced name list L1 externally via network N. The name identification processing device 10 may consist of an on-premise physical server, or a cloud server based on cloud computing, or a system combining these two. The name identification processing device 10 may be configured from a PC or an internal PC component.

More specifically, the name identification processing device 10 comprises a communication unit 11, a memory unit 12, a database unit 13, and a control unit 14. The communication unit 11 is an interface for the control unit 14 to perform wired or wireless communication with external devices such as the management terminal 50 and the information providing server 500. The memory unit 12 stores the operating program of the control unit 14, such as program of name identification processing P1, as well as various data required for the name identification. The memory unit 12 can be composed of RAM (Random Access Memory), ROM (Read Only Memory), PROM (Programmable ROM) such as flash memory, SSD (Solid State Drive), or HDD (Hard Disk Drive). The system can be configured with RAM (Random Access Memory) and ROM (Read Only Memory).

The database unit 13 is a device that stores the name identification list L1, which is a list of name data associated with family IDs. The database unit 13 is composed of RAM and ROM, PROM such as flash memory, SSD, or HDD. However, the database unit 13 may be a storage device provided outside the name identification processing device 10.

The control unit 14 accesses the intellectual property database 510, collects name data and family IDs contained in multiple rights-related information that are subjected for listing, and organizes the collected multiple name data based on family IDs to produce name identification list L1. Hereafter, the rights-related information that is the subject of listing is also referred to as “target information,” and the information that the control unit 14 collects from the intellectual property database 510 is also referred to as “data for listing”.

The listings may be rights-related information for a specified period, such as 10 or 20 years, rights-related information for a specified range of countries or regions, or rights-related information for a specified range of countries or regions of a specified period. All rights-related information in the intellectual property database may also be subject to listing. The target of listing can be set from the management terminal 50, etc., and can be changed as appropriate.

More specifically, the control unit 14 comprises information processing means 14a and name identification processing means 14b. The information processing means 14a collects data for listing from the intellectual property database 510 and stores them in the database unit 13. Namely, the information processing means 14a collects data for listing that includes a pair of name data and a family ID for each of the target information. The data for listing may include information such as filing date and registration date.

The name identification processing means 14b organizes the name data by family ID and extracts one or more name data indicating the same applicant, i.e., the same company, from the information collected by information processing means 14a and stored in database unit 13. Hereinafter, one or more name data indicating the same applicant (company, etc.) is also referred to as “same company data”. Namely, the name identification processing means 14b sorts the information that is randomly arranged in the database unit 13, which consists of pairs of name data and family IDs, by family ID, and then extracts the same company data according to the preset extraction conditions. Then, the name identification processing means 14b produces a name identification list L1 by assigning unique identification information to one or more name data in the extracted same company data.

The identification information may be any one of multiple name data associated with the same family ID, or it may be a character string common to these name data. The name identification processing means 14b may generate identification information that is not associated with the name data. The identifying information may be an individual ID. For a company that have filed only one application, if there is no use for display or printing, family ID may be used for identifying information.

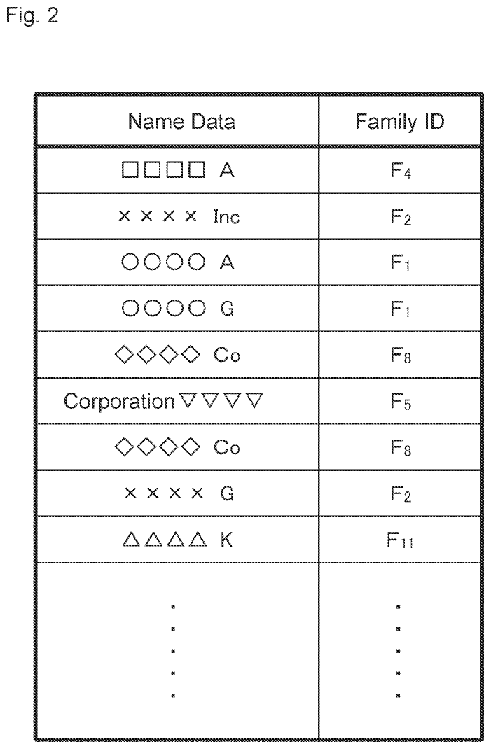

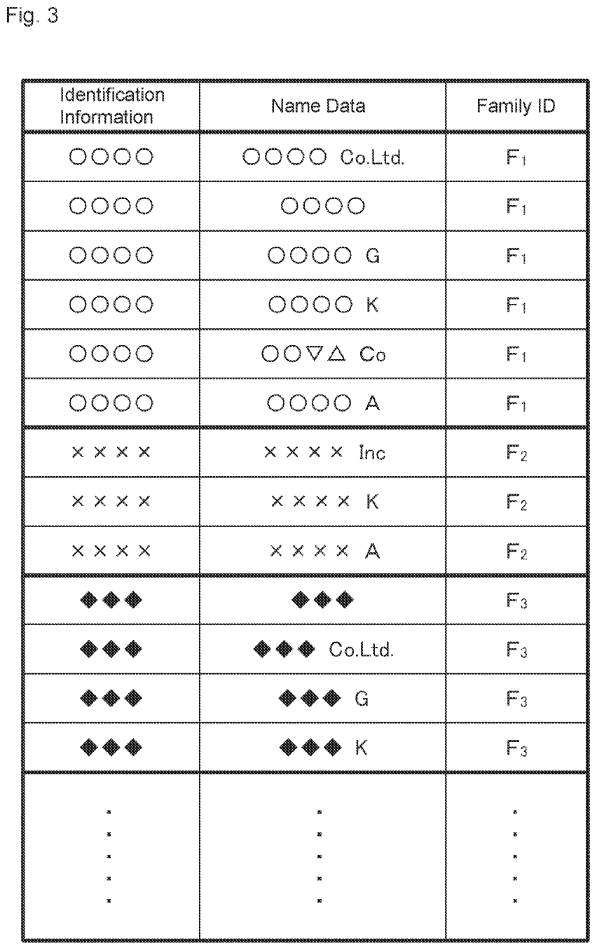

Referring now to FIGS. 2 and 3, method for making name identification list L1 of a company that have filed only one application (including patent family) is explained. In FIGS. 2 and 3, family IDs are denoted as “FN (N is any natural number)” for convenience. The examples of name data are for illustrative purposes only. The same applies in each of the subsequent figures.

FIG. 2 illustrates an example of data for listing stored in the database unit 13 by information processing means 14a. As illustrated in FIG. 2, name data and family IDs associated with the name data are randomly arranged in the database unit 13. The name identification processing means 14b sorts the information by family ID, as shown in FIG. 3. in the database unit 13, in which name data and family IDs are randomly arranged as shown in FIG. 2.

In the case where a company have filed only one application, name data with matching family IDs refer to the same company, while name data without matching family IDs refer to different companies. Based on this, the name identification processing means 14b assigns common identification information to multiple name data associated with the same family ID, as shown in FIG. 3. The name identification processing means 14b functions so that if there is overlapping name data among multiple name data associated with the same family ID, only one name data is retained while the others are deleted. Even if there is a family ID associated with only one name data (if there is no other name data associated with the same family ID), the name identification processing means 14b assigns unique identification information to the name data.

The above explanation is based on the presumption that one company files only one application. There are many companies that have filed multiple applications and have multiple family IDs associated with them. Namely, in the case where one company has multiple applications, multiple family IDs are assigned to the company. Therefore, the name identification processing means 14b preprocesses the same company data according to the designated extraction conditions for choosing the data. The extraction conditions are set from the management terminal 50 and may be changed as necessary.

In Embodiment 1, the name identification processing means 14b has a function to select all name data groups consisting of one or more name data to which the same family ID is linked and to determine the appearance rate of each name data. The name data group may consist of only one name data. Then, the name identification processing means 14b can select one or more name data indicating the same applicant or right holder by using the calculated rate of occurrence according to the extraction conditions corresponding appearance rate of each name data.

For example, the name identification processing means 14b may select all name data groups, including any name data, and determine the appearance rate of each name data. The any name data may be set in advance, or may be selected by the name identification processing means 14b according to the composition of name data in each name data group. The name identification processing means 14b may select all name data groups, including at least one of any name data, and determine appearance rate of each name data.

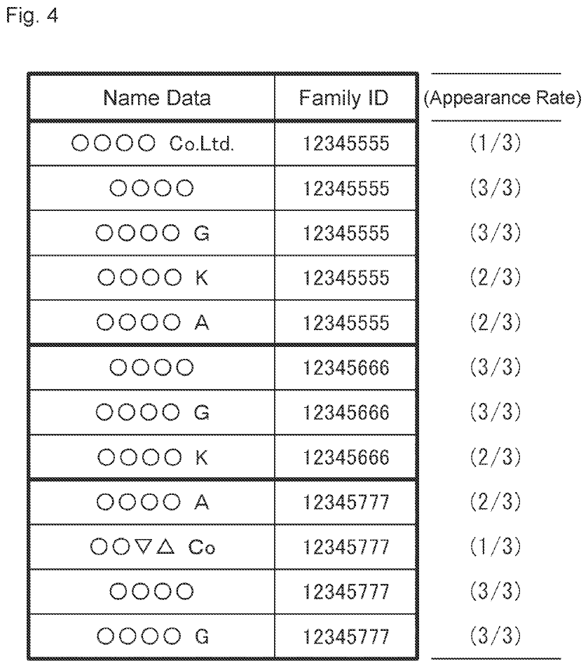

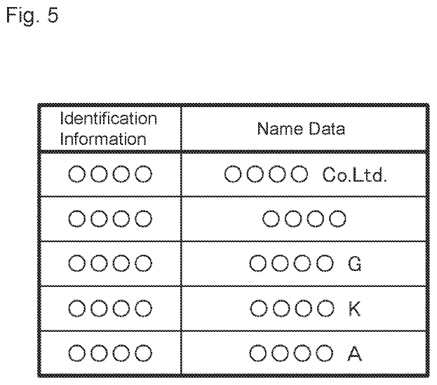

Here, referring to FIGS. 4 through 8, specific examples of the preprocessing performed by the name identification processing means 14b are described. FIGS. 4 through 7 show an example of a company filing three applications and a unique family ID is assigned for each of applications. For example, under an extraction condition in which the family ID with the maximum number of name data is associated (referred to as maximum data condition), the name identification processing means 14b extracts the name data that satisfy the condition. In FIG. 4, the name identification processing means 14b extracts five name data associated with the family ID “12345555”, and in FIG. 5, it assigns unique identification information to the five extracted name data.

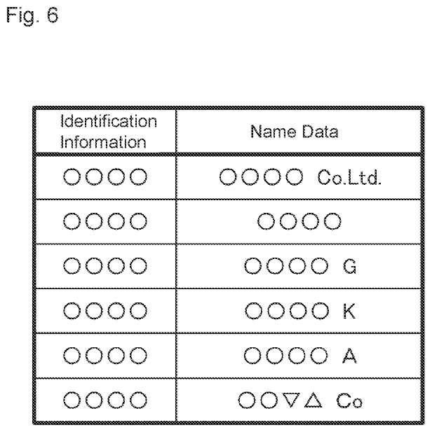

Under an extraction condition in which all name data of all name data groups are extracted by eliminating duplicates (referred to as total data condition), the name identification processing means 14b extracts the name data that satisfy the condition. In response to FIG. 4, the name sorting method 14b extracts three name data “◯◯◯◯”, “◯◯◯◯ G”, “◯◯◯◯ K” common to family IDs “12345555”, “12345666”, and “12345777”, a name data “Co., Ltd.” associated only with the family ID “12345555”, a name data “◯◯◯◯ A” common to family IDs “12345555” and “12345777” and a name data “◯◯∇Δ Co” associated only with the family ID “12345777”, as shown in FIG. 6. Then, the name identification processing means 14b assigns unique identification information to the six extracted name data.

Under an extraction condition in which name data whose appearance rate is higher than a preset threshold by eliminating duplicates (referred to as data appearance rate condition), the name identification processing means 14b extracts the name data that satisfy the condition. As shown in FIG. 4, examples of appearance rates are given in parentheses on the right side of the table. For example, if the threshold is set to 20% (⅕), the name identification processing means 14b extracts all name data, eliminating duplicates, as shown in FIG. 6. If the threshold is set to 40% ⅖), the name identification processing means 14b extracts four name data “◯◯◯◯”, “◯◯◯◯ G”, “◯◯◯◯ K” and “◯◯◯◯ A”.

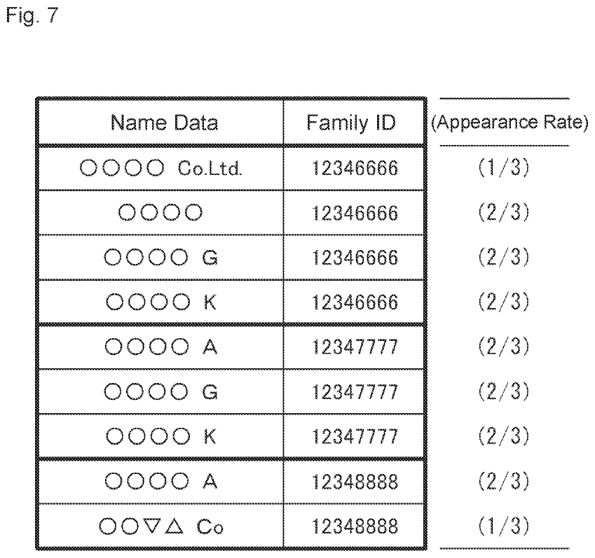

The name identification processing means 14b may select a group of name data that includes common name data not only in the case where there is name data common to all name data groups, as shown in FIG. 4, but also in the case where there is name data common to at least two groups of name data, as shown in FIG. 7. The name identification processing means 14b may select all name data groups that include at least one of any name data, and determine the occurrence rate of each name data in all selected name data groups. The name data may be set in advance, or may be selected by the name identification processing means 14b according to the composition of name data in each name data group. The name identification processing means 14b preprocesses other name data groups in the same manner as described above according to the respective extraction conditions, and creates a name identification list L1 by assigning unique identification information.

By the way, patent applications are sometimes filed jointly by several companies. In such cases, one family ID are associated with the names of multiple companies. Therefore, multiple company names may be mixed in the name identification list L1, especially when maximum number condition or total data condition are set. When there are many fluctuations in name data due to joint applications to many countries, the maximum number condition may cause the names of multiple companies to be listed in the name list L1. Also, the total data condition may cause the names of joint application partner companies to be listed in the name list L1.

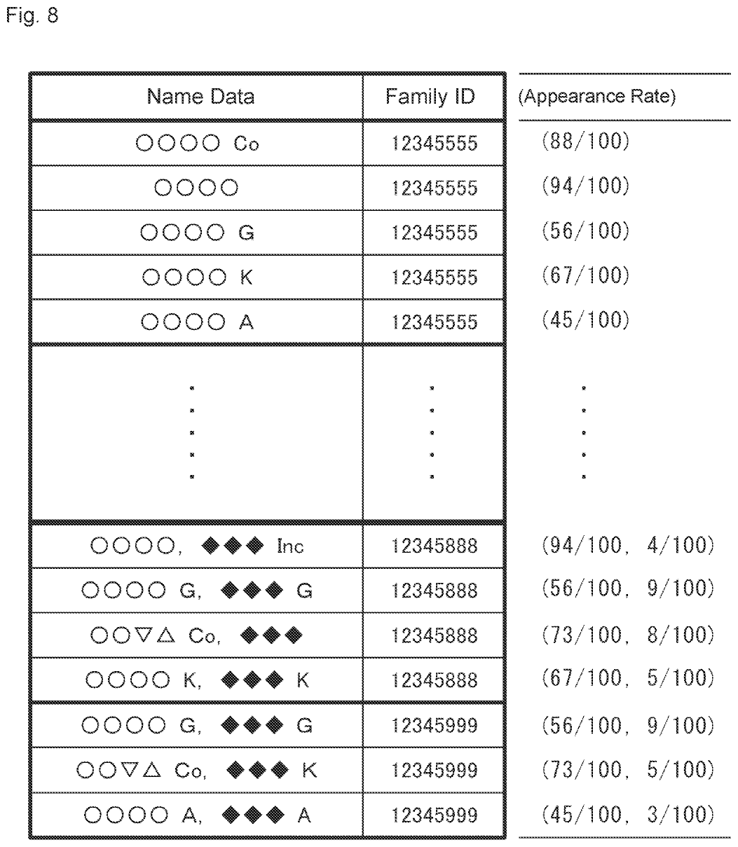

Therefore, the name identification processing means 14b in the Embodiment 1 basically employ data appearance rate condition takes into account of joint applications. Like FIG. 4, FIG. 8 shows the name data sorted by family ID for a group of name data of one company, including an example of two joint applications. As shown in parentheses on the right side of the table in FIG. 8, the name identification processing means 14b is configured to determine the percentage of appearance for each of the applicant's name data in the case of a joint application.

The number of joint applications is generally smaller than that of a single application, and the partner companies of joint applications may be changed as necessary depending on the content of the invention and the timing of application. Therefore, when a group of name data is extracted based on the name of a certain company, the number of name data groups that include the partner company of a joint application is relatively small. Therefore, setting the appearance rate threshold in consideration of technical fields and industry trends can prevent the inclusion of joint application partner companies in the name list L1. In the example in FIG. 8, setting the threshold to 10% would eliminate all the joint application partner companies.

The method of calculating the appearance rate is not limited to the above examples. The name identification processing means 14b may calculate the occurrence rate based on a single name data. For example, the name identification processing means 14b may determine the ratio of the number of appearance of other name data to the number of appearance of name data that have a relatively high number of appearance. In the example shown in FIG. 8, the appearance rate of the name data “◯◯◯◯ G” is about 60% ( 56/94) and that of the name data “ [symbol] K” is about 5% ( 5/94) when the name data “◯◯◯◯” is used as the reference. In this way, the same companies can be accurately extracted and other companies such as group companies can be eliminated.

The control unit 14 can be composed of an arithmetic device such as a CPU (Central Processing Unit) or GPU (Graphics Processing Unit) and a name identification processing program P1 that works with such an arithmetic device to perform the various functions described above. Namely, the name identification processing program P1 causes the control unit 14 and memory unit 12 as a computer to function as information processing means 14a and mane identification processing means 14b. The storage unit 12 is a computer-readable recording medium that records a name identification processing program.

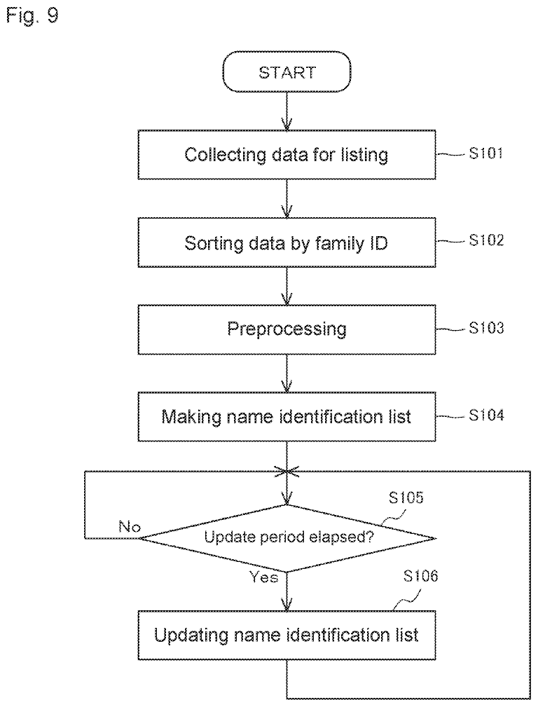

Next, referring to FIG. 9, an example of the method of making of identification list and the method of processing name identification are described.

First, the control unit 14 collects data from the intellectual property database 510 and stores them in the database unit 13 (step S101). Next, the control unit 14 sorts each name data in the database unit 13 by family ID (step S102).

Next, the control unit 14 performs preprocessing based on the specified extraction conditions, and extracts and organizes the same company data for each company. In other words, the control unit 14 create a table that organizes one or more name data indicating companies (Step S103). Then, the control unit 14 creates a name identification list L1 for each of the same company data by assigning unique identification information (step S104).

The control unit 14 waits until the preset update period elapses (step S105/No), and when the update period elapses (step S105/Yes), the updating of the name identification list L1 is executed. The update period is set to 1 day, 1 week, or 1 month, etc., and can be changed from the management terminal 50 or other terminals as appropriate. For example, the control unit 14 adds the name data contained in the target information that has increased during the update period and is not present in the name list L1 to the name list L1 as necessary (step S106).

As above, name identification processing device according to the Embodiment 1 produces name identification list L1 by accessing to intellectual property database 510 in which one or more name data indicating the applicant or right holder for one invention or device is associated with one family ID. Namely, the control unit 14 accessed the intellectual property database 510 and collect name data and family IDs contained in target information. The control unit 14 then organizes the collected name data based on family IDs to create a name identification list L1. The family ID is the identification information commonly assigned to patent families, and the same family ID is assigned to the same company, no matter how far apart the company names may be. Therefore, the name identification processing device 10 can provide a name Identification list L1 that organizes name data based on family IDs to achieve highly accurate name identification irrespective of a degree of similarity between names.

In the Embodiment 1, the control unit 14 extracts one or more name data indicating the same applicant or right holder according to the extraction conditions for discarding and selecting name data, and creates a name identification list L1 by assigning unique identification information to the extracted name data. The control unit 14 can create a name list L1 with a sufficient amount of information by useful preprocessing such as duplicate elimination of name data when creating the name list L1. This can reduce memory resources as well as improve user convenience. In addition, the assignment of unique identification information increases the sense of unity for each company in the name identification list L1, which leads to ensuring accessibility of the name identification list L1 and improves visibility when the list L1 is displayed or printed out.

For example, the control unit 14 may select all name data groups including any name data and determine the occurrence rate of each name data in all selected name data groups. The control unit 14 may also select all name data groups including at least one of any name data and determine the occurrence rate of each name data in all selected name data groups. The control unit 14 may extract one or more name data indicating the same applicant using the obtained appearance rate according to the extraction condition corresponding to the appearance rate (data appearance rate condition). This can eliminate the names of joint application partners, infrequent notational distortions, and obvious typographical errors, and create and provide a more accurate name identification list L1.

The name identification list L1 may be provided to a PC or server via network N. In this case, the identification list L1 may be provided as a data file such as a MICROSOFT EXCEL (registered trademark) XLS file, CSV (Comma-Separated Values) file, or text file. However, the name identification list L1 may also be provided as a printout on paper media.

### Variation 1

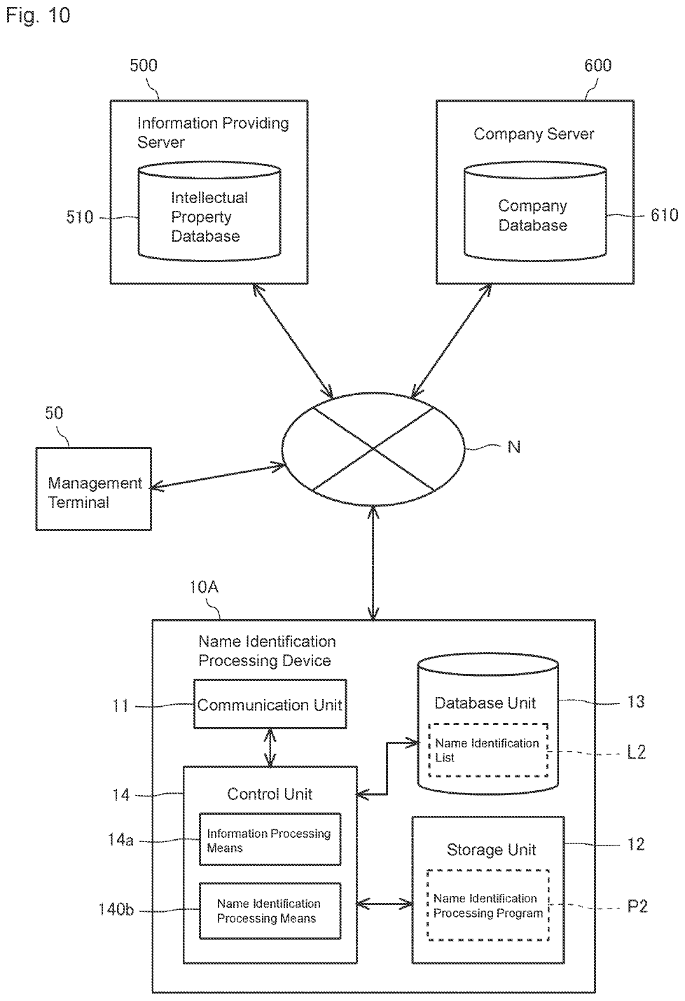

Referring to FIG. 10, an example of the name identification processing device and its peripheral configurations of the Variation 1 of the Embodiment 1 is explained. The name identification processing device 10A in the Variation 1 extends the process to names similar to the name data in the name identification list. The same symbols are used for the same configuration as those described above based on FIG. 1, etc., and repeated explanations are omitted.

The name identification processing device 10A in the Variation 1 has a function to expand the name identification list L1 based on the company data in the company database 610 of the company server 600 communicating via network N. The company server 600 is a server that manages company names and information associated with them, such as the constituent stocks of stock indices such as the Japan Stock Average (Nikkei 225) or the S&P 500 (S&P 500 index), or stocks handled by financial institutions such as Morgan Stanley. The company server 600 may be a server used and managed by a rating agency such as MSCI (Morgan Stanley Capital International), FTSE, or Sustainalytics, or the like. The company server 600 may consist of a cloud server based on cloud computing, or a physical server, or a system combining these two.

The company database 610 is a list of multiple company data indicating company names. The memory unit 12 stores the name identification processing program P2 as an operating program of the control unit 14. The control unit 14 has information processing means 14a and name identification processing means 140b. If there exists company data similar to the name data in the database unit 13 and not in the database unit 13, the name identification processing means 140b takes it into the database unit 13 to complete the name identification list L2.

The name identification processing means 140b of the Variation 1 determines whether the company data is similar to the name data based on the match rate between the string of the company data and the string of the name data. Namely, the name identification processing means 140b determines that the two are similar if the match rate between the string in the company data and the string in the name data is equal to or greater than a predetermined similarity threshold, and determines that the two are dissimilar if the match rate is less than the similarity threshold. Other and alternative configurations are the same as in the above example described using FIG. 1, etc.

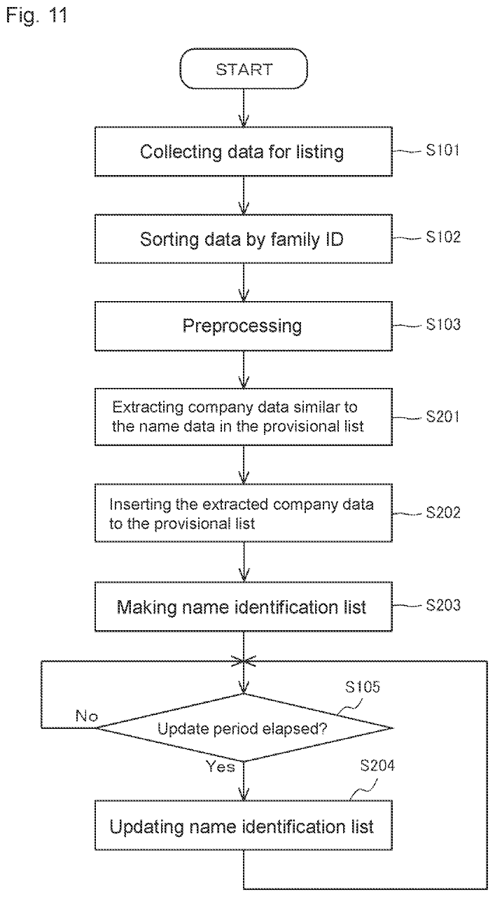

Next, referring to FIGS. 11 to 13, an example of the method of making of identification list and the method of processing name identification according to the Variation 1 are described. Processes equivalent to those in FIG. 9 will be abbreviated with the same step numbers.

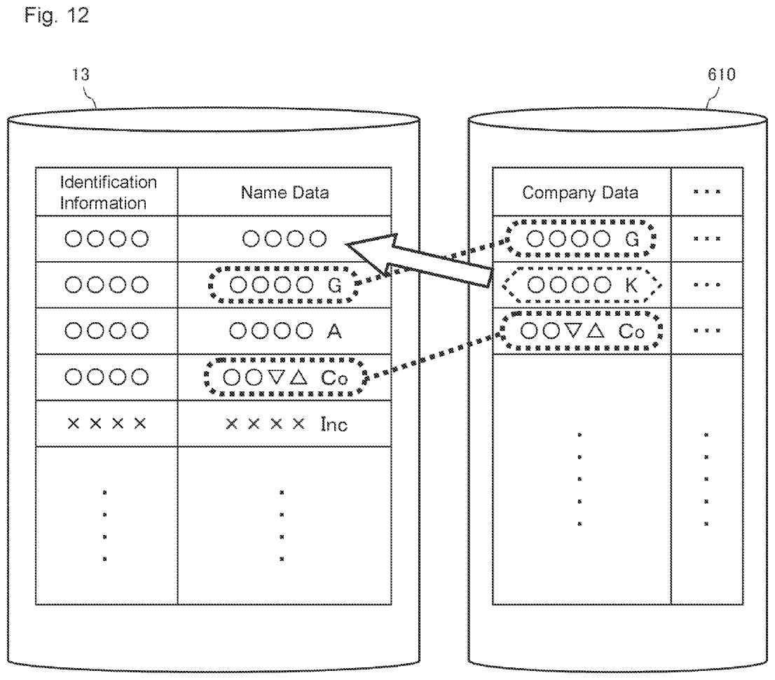

First, the control unit 14 performs steps S101-S103 in the same manner as in the example in FIG. 9. At this time, the table information in memory unit 12 is in a state in which the name data is sorted by unique identification information, as shown in FIG. 12. The table information in such a state is referred to as a provisional list.

Next, the name identification processing means 140b matches the name data in the provisional list with the company data in the company database 610, and extracts company data similar to the name data in the provisional list that does not exist in the provisional list. In FIG. 12, the name data and the identical company data are connected by dashed lines. The company data with similar name data is enclosed with a dashed line (hexagon), and a white arrow is extended from the dashed line to the similar name data. Namely, in FIG. 12, the name identification processing means 140b has judged that the company data “◯◯◯◯ K” and the name data “◯◯◯◯” are similar (step S201).

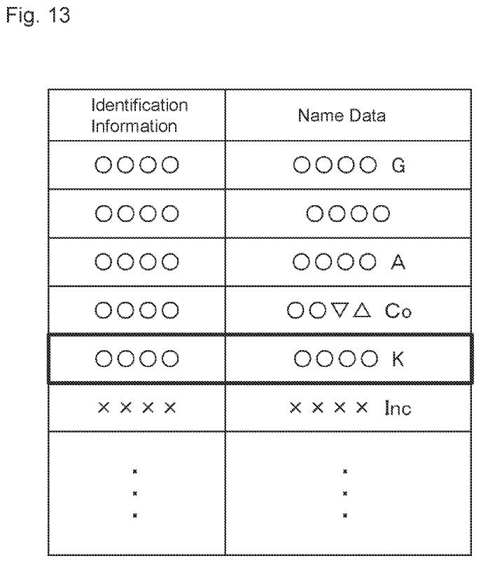

Next, the name identification processing means 140b inserts the extracted company data at a location adjacent to the name data similar to it (step S202). Then, the name identification processing means 140b creates a name identification list L2 by assigning the same identification information as the similar name data to the inserted company data (step S203), as shown in the example in FIG. 13.

The name identification processing means 140b executes the update process of the name identification list L2 when the update period has elapsed (step S105/Yes). In the update process, the name identification processing means 140b adds the name data included in the target information that has increased during the update period and does not exist in the name identification list L2 (step S204).

As described above, the name identification processing device 10A in the Variation 1 creates a name identification list L2 by assigning the same identification information to company data similar to the name data collected from the intellectual property database 510. In the name list L2, name data and similar company data are grouped by unique identification information. Thus, the name identification processing device 10A extends the name identification list consisting of multiple name data obtained from the intellectual property database 510 to company data similar to the name data. Therefore, supplying the name identification list L2 externally in various ways can provide an environment in which name identification processing can be performed quickly and efficiently. Other effects are the same as in the main part of Embodiment 1 described above.

### Variation 2

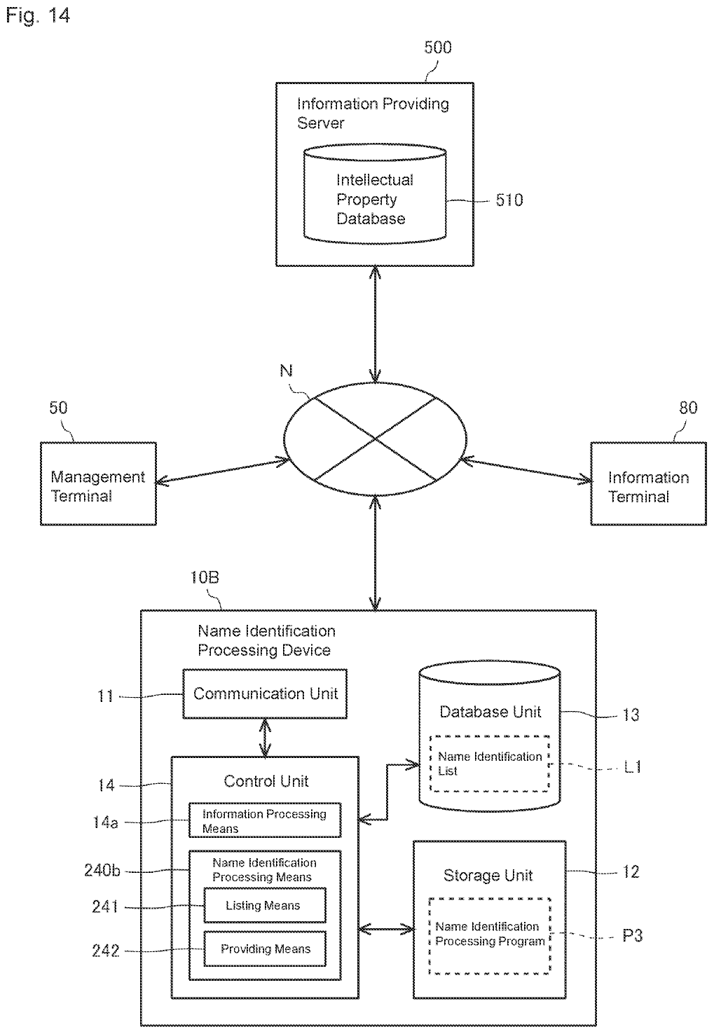

Referring to FIG. 14, an example of the name identification processing device and its peripheral configurations of the Variation 2 of the Embodiment 1 is explained. The name identification processing device 10B in the Variation 2 has a function to execute name identification processing using a name identification list in response to external input. The same symbols are used for each configuration equivalent to those described based on FIG. 1, etc., and explanations are omitted.

In the name identification processing device 10B of the Variation 2, the memory unit 12 stores the name identification processing program P3 as an operating program of the control unit 14. The control unit 14 has information processing means 14a and name identification processing means 240b including listing means 241 and providing means 242. The listing means 241 functions in the same manner as the name identification processing means 14b described above to create the name identification list L1.

The providing means 242 obtains the request information including company data indicating company names from the information terminal 80 or the like. The request information is company data each associated with various information. The information terminal 80 comprises a PC or the like. The providing means 242 matches the request information obtained from outside with the name identification list L1, and assigns common data to the company data that matches the name data to which the same identification information in the name identification list L1 is linked and organizes them. The common data is unique information that is assigned to the names of the same companies.

In the above matching process, the provisioning means 242 organizes the company data that does not match any of the name data in the name identification list L1 and for which similar name data exist in the name identification list L1, by using the identification information associated with the similar name data. Here, the company data that does not match any of the name data in the above matching is referred to as “mismatch data”.

Namely, if there is company data that matches other name data to which the same identification information is associated as the name data similar to the mismatch data, the providing means 242 organizes the mismatch data by assigning the same common data as the company data to the mismatch data. On the other hand, if there is no other company data that matches the name data similar to the mismatch data and other name data to which the same identification information is tied, the providing means 242 organizes the mismatch data by assigning new common data to it. If multiple mismatch data are similar to the same name data, providing means 242 will assign the same common data to these mismatch data.

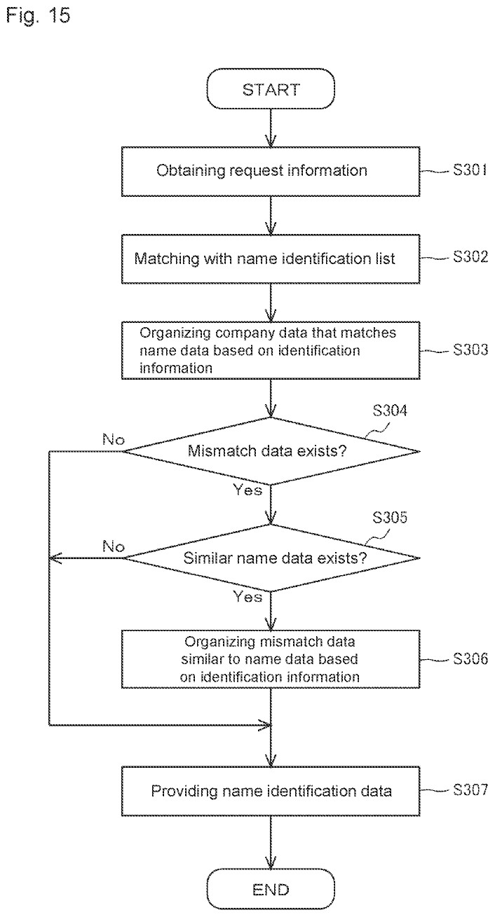

Next, referring to FIGS. 15 through 18, an example of the operation in the name identification processing method of the Variation 2 be explained.

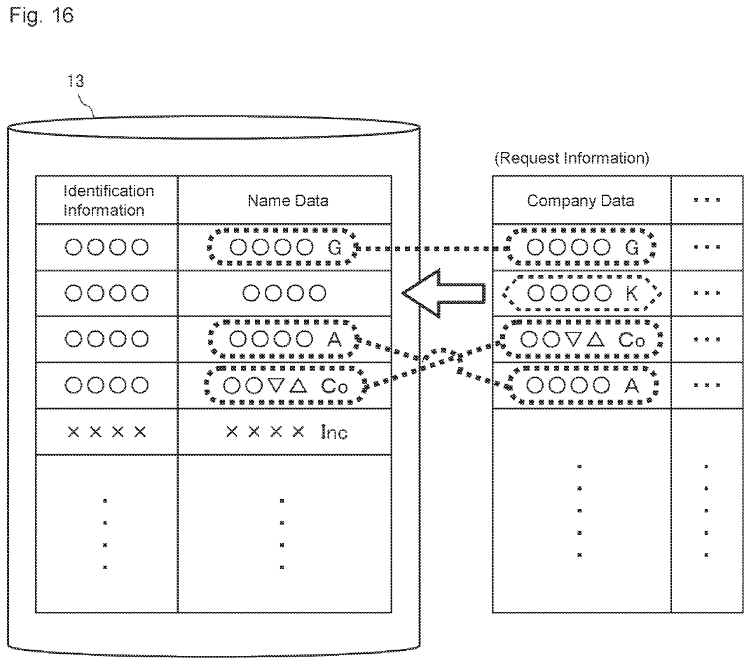

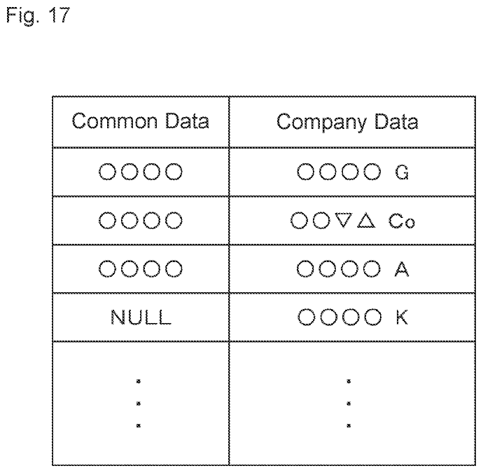

The control unit 14 acquires the request information for name identification from the outside (step S301). The control unit 14 matches each company data in the request information with each name data in the name identification list L1 (step S302), and organizes the company data that matches any of the name data based on the identification information for the name data. In FIG. 16, the name data and the identical company data are connected by dashed lines. In this situation, the control unit 14 organizes the company data “◯◯◯◯ G”, “◯◯◯◯ A”, and “◯◯∇Δ Co”, which share the same identification information, by assigning common data to them (step S303), as shown in FIG. 17.

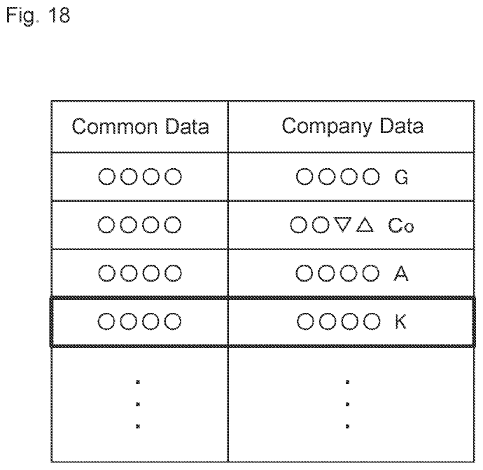

Furthermore, if mismatch data exists (step S304/Yes), the control unit 14 determines whether name data similar to the mismatch data exists in the name list L1 (step S305). If there is name data similar to the mismatch data (step S305/Yes), the control unit 14 organizes the mismatch data based on the identification information associated with the name data. As illustrated by the white arrows in FIG. 16, the control unit 14 places “◯◯◯◯ K”, which is mismatch data and judged to be similar to “◯◯◯◯”, adjacent to the company data that matches the name data whose identification information is “◯◯◯◯” and assigns common data, as shown in FIG. 18 (Step S306).

The control unit 14 then provides the name identification data, which organizes the requesting company data based on the family ID, to outside. For example, the control unit 14 returns the name identification data to the information terminal 80. The name matching data may be provided in a data file such as an XLS file, CSV file, text file, or printed out on paper media (step S307). If no mismatch data exists in step S304, or if no name data similar to the mismatch data exists in step S305, the process moves to step S307.

As described above, the name identification processing device 10B in the Variation 2 has the function of providing name identification processing using the name identification list L1 upon external request. In other words, the control unit 14 matches the request information for name identification list L1 with the request information for company data, and assigns common data to company data that matches or is similar to the name data associated with the same identification information, and organizes them. Here, the same family ID is always assigned to the same company, regardless of the degree of similarity between company names, and the identification information is assigned based on the family ID. Therefore, the name identification processing device 10B can provide highly accurate name identification processing based on the family ID.

By the way, the listing means 241 may produce name identification list L2 in the same way as the name identification processing means 140b in the Variation 1 above. In other words, providing means 242 may use the name identification list L2 to perform name identification in the same manner as above. The name identification processing device 10B may also be configured without the listing means 241 and use the name identification list L1 or L2 that is created externally and stored in the database unit 13.

Furthermore, providing means 242 does not need to determine the degree of similarity between the name data and the company data. In other words, the name identification processing device 10B in the Variation 2 may provide name identification data organized by assigning common data based on identification information to company data that matches the name data, as shown in FIG. 17. In this case, providing means 242 matches the request information for name identification list L1 or L2 and organizes it by assigning common data to the company data that matches the name data associated with the same family ID. Other configurations, alternative configurations, and operations are the same as in the main part of the Variation 1 of the Embodiment 1.

### Embodiment 2

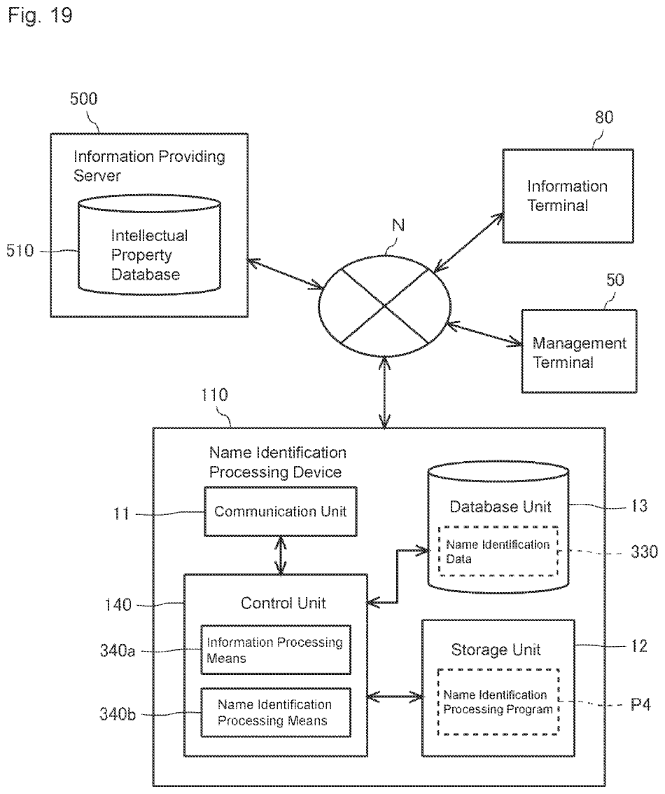

Referring to FIG. 19, an example of the name identification processing device and its peripheral configurations of the Embodiment 2 is explained. The name identification processing device of the Embodiment 2 is configured to utilize the information in the intellectual property database 510 as well as the name identification list L1 or L2. The same symbol is used for the same configuration as in the Embodiment 1 above, and repeated explanations are omitted.

In the name identification processing device of the Embodiment 2, the memory unit 12 stores the name identification processing program P4 as an operating program of the control unit 140. The control unit 140 comprises the information processing means 340a and the name identification processing means 340b. In other words, the name identification processing program P4 is a program for causing the control unit 140 and the memory unit 12 as a computer to function as the information processing means 340a and the name identification processing means 340b. The information processing means 340a acquires a signal requesting the name identification process from the information terminal 80 and information on company data indicating the name of the company.

The name identification processing means 340b matches the request information with the intellectual property database 510 and organizes it by assigning the same common data to the company data that matches the name data associated with the same family ID. The name identification processing means 340b may match the request information with the intellectual property database 510 and organize it by assigning unique common data to company data that matches or is similar to the name data associated with the same family ID. Considering that one company files multiple applications, the name identification processing means 340b preferably organize the intellectual property database 510 according to the extraction conditions such as maximum number conditions, total data condition, or data appearance rate condition, and then perform the matching process. Considering joint applications, the name identification processing means 340b preferably organize the intellectual property database 510 according to data appearance rate condition. Other and alternative configurations are the same as in each of the examples in the Embodiment 1 above.

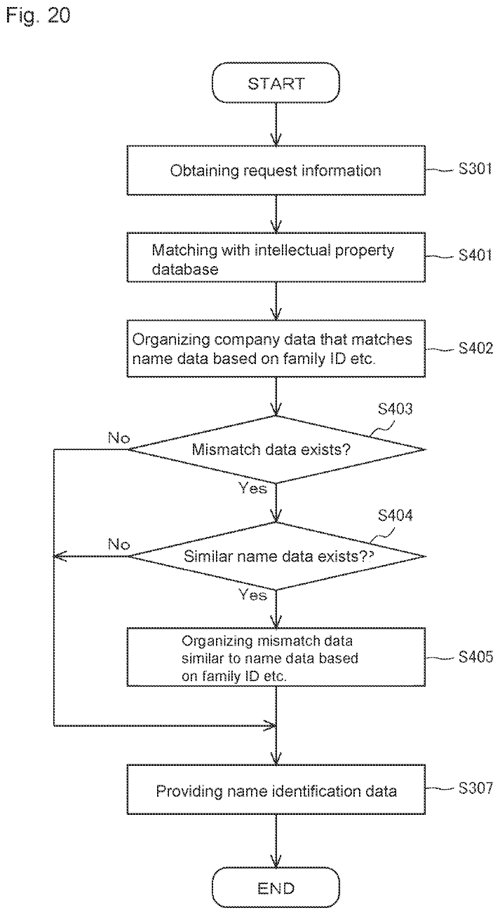

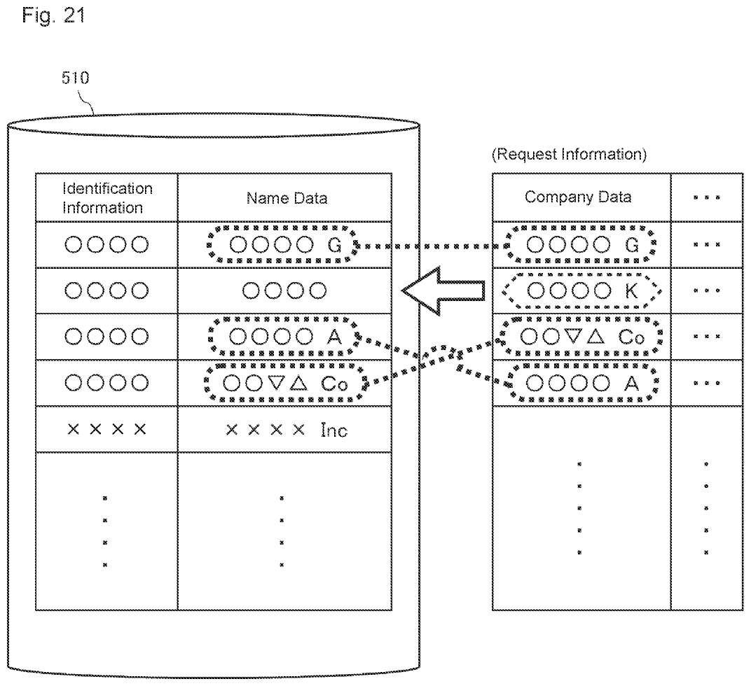

Next, referring to FIGS. 17 and 18 as well as FIGS. 20 and 21, an example of the operation in the name identification processing method of the Embodiment 2 is explained. The same processes as those described in FIG. 15 above are marked with the same step numbers and are omitted from the description.

The control unit 140 obtains the request for name identification and the request information from the outside (step S301). The control unit 140 matches each company data in the request information with the intellectual property database 510. At that time, the control 140 preferably organize the information in the intellectual property database 510 according to the extraction conditions, as shown in the example in FIG. 21 (step S401).

The control unit 140 organizes the company data that matches any of the respective name data in the intellectual property database 510 based on the family ID or identification information of the name data. Namely, as in the example in FIG. 17, company data that share the same family ID or identification information are assigned the same common data and organized (step S402). If there is mismatch data (step S403/Yes), the control unit 140 determines whether name data similar to the mismatch data exists in the intellectual property database 510 (step S404).

If there is name data similar to the mismatch data (step S404/Yes), the control unit 140 organizes the mismatch data based on the family ID or identification information associated with the name data. The control unit 140 places the mismatch data adjacent to the name data (“◯◯◯◯G”: FIG. 21) that is similar to the mismatch data and the name data to which the same family ID or identification information is associated (“◯◯◯◯ G”, “◯◯◯◯ A”, “◯◯∇Δ Co”: FIG. 21), and gives common data (Step S405/FIG. 18).

The control unit 140 then provides the name identification data 330 that organizes the company data of the request information based on the family ID or identification information to outside (step S307). The control unit 140 may store the produced nomenclature data 330 in database unit 13 for backup. The name identification processing device 110 may be configured without the database unit 13. If no mismatch data exists in step S403, or if no name data similar to the mismatch data exists in step S404, the process moves to step S307.

As described above, the name identification processing device 110 of the Embodiment 2 performs name identification processing using the intellectual property database 510 in response to an external request. In other words, the control unit 140 matches the request information containing multiple company data with the intellectual property database 510, and organizes the same common data for company data that matches or is similar to the name data to which the same family ID or identification information is associated. Since the same family ID is always assigned to the same company, regardless of the degree of similarity between company names, the name identification processing device 110 can provide highly accurate name identification processing based on the family ID. Other effects are the same as those of the Embodiment 1 described above.

### Embodiment 3

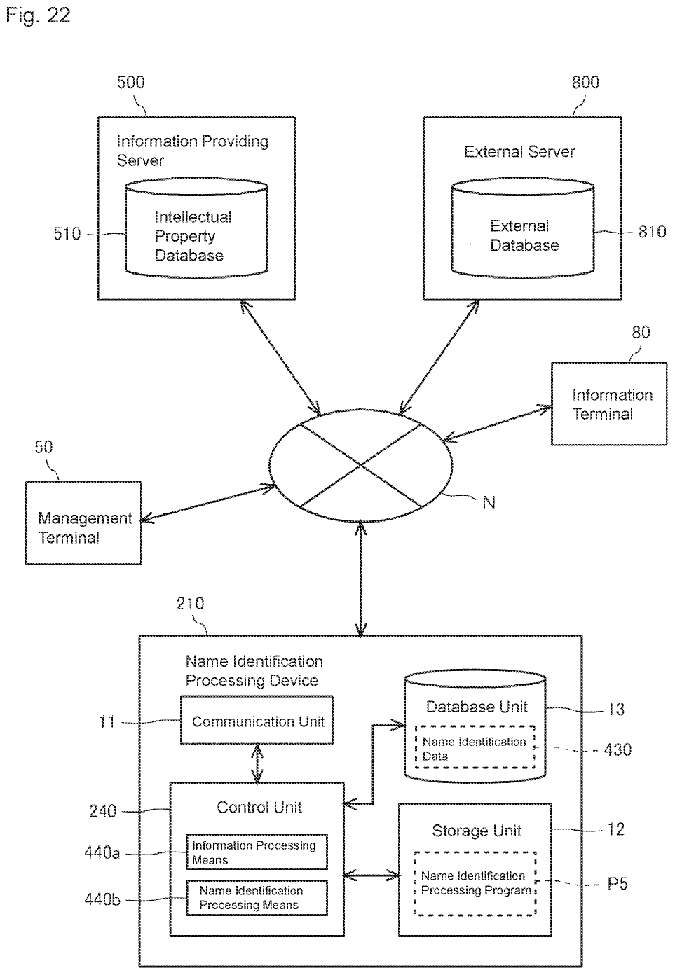

Referring to FIG. 22, an example of the name identification processing device and its peripheral configurations of the Embodiment 3 is explained. The name identification processing device 210 according to the Embodiment 3 is configured to utilize the information in the intellectual property database 510 as well as the name lists L1 or L2 to process the name identification in the external databases. The same symbols are used for the same configuration as in the Embodiment 1 and Embodiment 2 above, and repeated explanations are omitted.

The name identification processing device 210 is communicatively connected via network N to an external server 800 that stores an external database 810 in which company data is listed. The external server 800 is used by various companies to manage the names of companies, such as business partners, and information associated with them. The external server 800 includes the company server 600 described above. The external server 800 is composed of a cloud server based on cloud computing, or a physical server, or a system combining these two.

In the name identification processing device 210 according to the Embodiment 3, the name identification processing program P5 is stored in the memory unit 12 as the operating program of the control unit 240. The control unit 240 comprises the information processing means 440a and the name identification processing means 440b. In other words, the name identification processing program P5 is a program for making the control unit 240 and the memory unit 12 as a computer function as the information processing means 440a and the name identification processing means 440b. When the information processing means 440a receives a signal requesting the name identification processing from the outside, it outputs the signal to the name identification processing means 440b.

The name identification processing means 440b matches the external database 810, which lists multiple company data, with the intellectual property database 510, and assigns unique common data to the company data in the external database 810 that matches the name data to which the same family ID is linked and organizes them. In addition, the name identification processing means 440b organizes the company data that does not match any of the name data in the intellectual property database 510, but for which similar name data exists in the intellectual property database 510, based on the family ID associated with that similar name data. Considering that one company files multiple applications, the name identification processing means 440b preferably organize the intellectual property database 510 according to the extraction conditions such as maximum number conditions, total data condition, or data appearance rate condition, and then perform the matching process. Considering joint applications, the name identification processing means 440b preferably organize the intellectual property database 510 according to data appearance rate condition.

In the above matching, company data that does not match any of the respective name data is referred to as “mismatch data”. Namely, when there is company data that matches other name data to which the same family ID is linked as the name data similar to the mismatch data, the name identification processing means 440b assigns the same common data as that company data to the mismatch data and organizes it. On the other hand, if there is no company data that matches the other name data associated with the same family ID as the name data similar to the mismatch data, the name identification processing means 440b assigns new common data to the mismatch data and organizes them. However, if multiple mismatch data are similar to the same name data, the name identification processing means 440b assigns the same common data to these mismatch data.

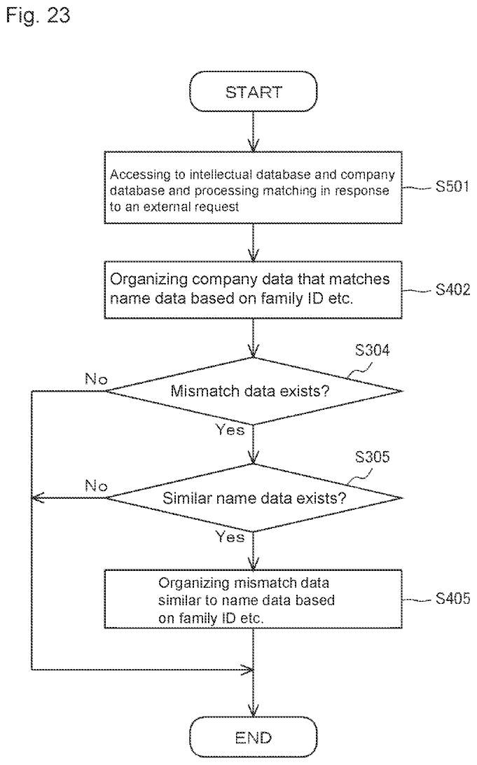

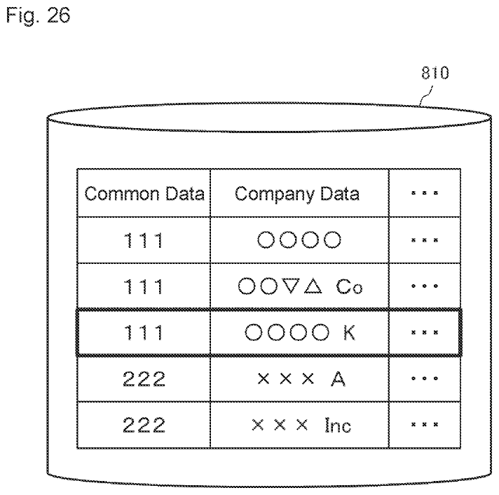

Next, referring to FIGS. 23 and 26, an example of the operation in the name identification processing method of the Embodiment 3 is explained. The same processes as those described in FIG. 15 above are marked with the same step numbers and are omitted from the description.

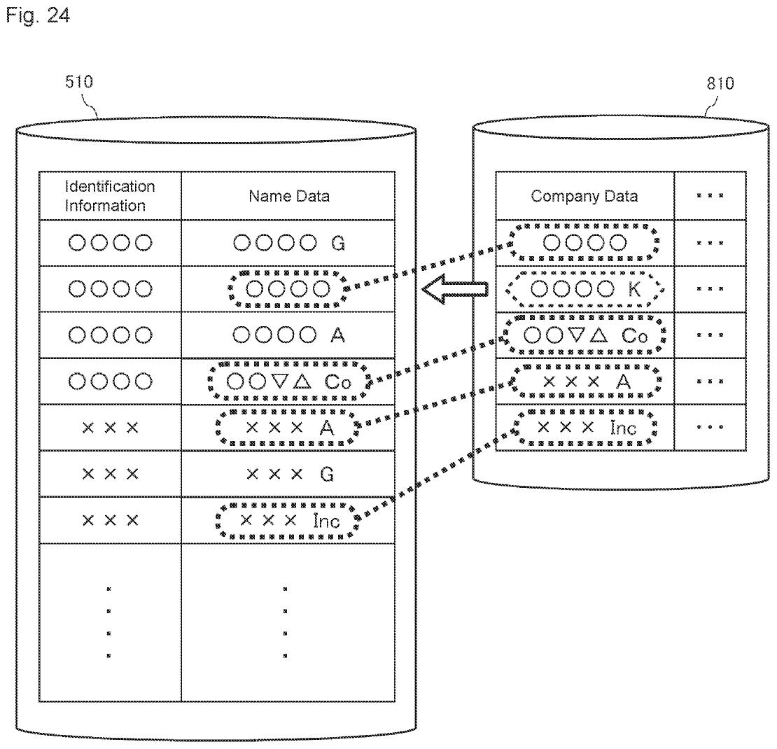

The control unit 240 accesses the intellectual property database 510 and the external database 810 in response to an external request for name identification. At that time, the control unit 240 preferably organize the information in the intellectual property database 510 according to the extraction conditions, as shown in FIG. 24. Then, the control unit 240 matches each company data in the external database 810 with each company data in the intellectual property database 510 (step S501).

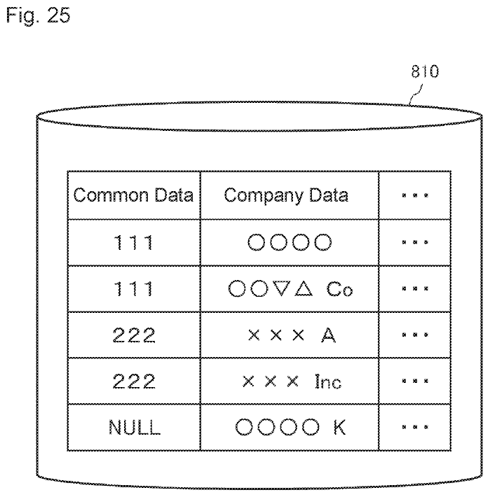

The control unit 240 organizes the company data that matches any of the respective name data in the intellectual property database 510 based on the family ID or identification information of the name data. In FIG. 24, the name data and the same company data are connected by dashed lines. As illustrated in FIG. 25, the control unit 240 assigns the same common data (111) to the company data “◯◯◯◯” and “◯◯◯◯ Co” that share the same family ID or identification information, assigns the same common data (222) to the company data “XXX A” and “XXX Inc” that share the same family ID or identification information, and organizes them (step S402).

Furthermore, if the mismatch data exists (step S304/Yes), the control unit 240 determines whether name data similar to the mismatch data exists in the intellectual property database 510 (step S305). If there is name data similar to the mismatch data (step S305/Yes), the control unit 240 organizes the mismatch data based on the family ID associated with the name data. Namely, the control unit 240 places the mismatched data adjacent to the company data that matches the name data associated with the same family ID or identification information as the name data that is similar to the mismatched data. More specifically, as illustrated by the white arrows in FIG. 24, the control unit 240 places “◯◯◯◯ K.” which is mismatch data and determined to be similar to “◯◯◯◯,” adjacent to the company data that matches the name data whose identification information is “◯◯◯◯,” as shown in FIG. 26, and assign common data (111) to it (Step S405).

If no mismatch data exists in step S304, or if no name data similar to the mismatch data exists in step S305, the control unit 240 terminates the name matching process. The control unit 240 may acquire each name data and the common data associated with these name data in the external database 810 and store them in the database unit 13 as the name identification data 430 for backup. Also, the name identification processing device 210 may be configured without the database unit 13.

As described above, the name identification processing device 210 according to the Embodiment 3 provides name identification processing using the intellectual property database 510 to an external database. Namely, the control unit 240 matches the external database 810 with the intellectual property database 510 and organizes the same common data for company data that matches or is similar to the name data associated with the same family ID or identification information. Since the same family ID is always assigned to the same company, regardless of the degree of similarity between company names, the name identification processing device 210 can provide highly accurate name matching processing.

By the way, the control unit 240 may not have a function to determine the similarity between the name data and the company data. In other words, the name identification processing device 210 may terminate the name matching process when it has assigned common data based on the family ID or identification information to the company data that matches the name data, as shown in FIG. 20. In this case, the control unit 240 matches the external database 810 with the intellectual property database 510 and organizes the company data in the external database 810 that matches the name data to which the same family ID or identification information is linked by assigning unique common data. Other effects are the same as in the Embodiment 1 and the Embodiment 2 above.

Each of the above-mentioned embodiments are specific examples in the name identification processing device, the name identification processing program, recording media, the method of making name identification list and the method of name identification processing. The technical scope of the present invention is not limited to these examples. For example, the database unit 13 may be located outside of the name identification processing device 10, 10A, 10B, 110, 210 (hereinafter simply referred to as “name identification processing device”). The database unit 13 may be provided outside of the name identification processing device. Also, the management terminal 50 may be configured to function as the name identification processing device in each of the embodiment.

The Variation 1 described above shows an example in which the name identification processing means 140b determines whether the company data is similar to the name data based on the match rate between the string of the company data and the string of the name data, however, it is not limited to this. The name matching means 140b may use natural language processing, such as Word2Vec, to determine whether the company data is similar to the name data or not. Also, the name identification processing means 140b may apply morphological analysis to each of the company data and each name data to decompose them into morphemes with part-of-speech information, and then make a distributed representation of each morpheme and compare the vectors to determine whether the company data and name data are similar or dissimilar. Similarly, providing means 242, name identification processing means 340b and 440b may use natural language processing, such as Word2Vec, to determine whether the company data (mismatch data) and the name data are similar.

Each of the above mentioned configurations (including variations) can be combined as needed to construct a new name identification processing device. For example, the name identification processing device 210 according to the Embodiment 3 may use the name identification list L1 or L2 of the Embodiment 1 instead of the intellectual property database 510 to process the names of companies in the external database 810. In other words, the control unit 240 of the name identification processing device 210 may match the external database 810 in which multiple company data indicating company names are listed with the name identification list L1 or L2, and assign common data to the company data in the external database 810 that matches the name data to which the same identification information is attached. Also, during matching, the control unit 240 may organize the company data that does not match any of the name data in the intellectual property database 510, but for which similar name data exists in the intellectual property database 510, based on the identification information associated with the similar name data. The control unit 240 may use natural language processing, such as Word2Vec, to determine whether the company data and the name data are similar.

### SYMBOLS

10, 10A, 10B, 110, 210: name identification processing device
11: communication unit
12: memory unit
13: database unit
14, 140, 240: control unit
14a, 340a, 440a: information processing means
14b, 140b, 240b, 340b, 440b: name identification processing means
50: management terminal
80: information terminal
241: listing means
242: providing means
330, 430: name identification data
500: information providing server
510: intellectual property database
600: company server
610: company database
800: external server
810: external database
L1, L2: name identification list
N: network
P1-P5: name identification processing program.

What is claimed is:

1. A name identification processing device comprising: a control unit, and
wherein the control unit is configured to produce a name identification list by accessing to an intellectual property database in which one or more name data indicating the applicant or right holder for one invention or device is associated with one family ID, collecting the name data and the family ID of industrial property rights that are subjected to listing and organizing the collected name data based on the family ID.

2. The name identification processing device according to claim 1, comprising:
wherein the control unit is configured to produce the name identification list by extracting the name data indicating the same applicant or right holder according to an extraction condition for discarding and selecting the name data, and producing the name identification list by assigning unique identification information to the extracted name data.

3. The name identification processing device according to claim 2, comprising:
wherein the control unit is configured to select all name data groups including at least one of any name data among the name data groups consisting of one or more name data associated with the same family ID, determine the occurrence rate of each name data in all selected name data groups and extract one or more name data indicating the same applicant using the obtained appearance rate according to the extraction condition corresponding to the appearance rate.

4. The name identification processing device according to claim 2, comprising:
wherein the control unit is configured to select all name data groups including at least one of any name data among the name data groups consisting of one or more name data associated with the same family ID, determine the occurrence rate of each name data in all selected name data groups and extract one or more name data indicating the same applicant using the obtained appearance rate according to the extraction condition corresponding to the appearance rate.

5. The name identification processing device according to claim 2, comprising:
wherein the control unit comprises a providing means that match the request information including company data indicating company names with the name identification list and organize by assigning a common data to the company names with the same identifying information.

6. The name identification processing device according to claim 2, comprising:
wherein the providing means, during the matching, organizes the company data that does not match any of the name data in the name identification list and for which similar name data exist in the name identification list by using the identification information associated with the similar name data.

7. The name identification processing device according to claim 2, comprising:
wherein the control unit is configured to match the external database in which multiple company data indicating company names are listed with the name identification list and organize by assigning a common data to the company data in the external database that matches the name data to which the same identification information is attached.

8. The name identification processing device according to claim 7, comprising:
wherein the control unit is configured to organize the company data that does not match any of the name data in the intellectual property database, but for which similar name data exists in the intellectual property database, based on the family ID associated with that similar name data.

9. A name identification processing device comprising: a control unit, and
wherein the control unit is configured to match the external database in which multiple company data are listed with an intellectual property database in which one or more name data indicating the applicant or right holder for one invention or device is associated with one family ID, and organize by assigning a common data to the company data in the external database that matches the name data to which the same family ID is linked.

10. The name identification processing device according to claim 9, comprising:
wherein the control unit is configured to organize the company data that does not match any of the name data in the intellectual property database, but for which similar name data exists in the intellectual property database, based on the family ID associated with that similar name data.

11. A method of making a name identification list, the method comprising:
accessing to an intellectual property database in which one or more name data indicating the applicant or right holder for one invention or device is associated with one family ID: collecting the name data and the family ID of industrial property rights that are subjected to listing; and
organizing the collected name data based on the family ID.

12. A method of name identification processing, comprising:
matching the external database in which multiple company data are listed with an intellectual property database in which one or more name data indicating the applicant or right holder for one invention or device is associated with one family ID; and
organizing by assigning a common data to the company data in the external database that matches the name data to which the same family ID is linked.
